(19) United States
(12) Patent Application Publication
(10) Pub. No.: US 2025/0132067 A1
(43) Pub. Date: Apr. 24, 2025

(54) LEAD WIRE FOR ELECTRICAL SUBMERSIBLE PUMPS

(71) Applicant: Schlumberger Technology Corporation, Sugar Land, TX (US)

(72) Inventors: William GOERTZEN, Lawrence, KS (US); Varun Vinaykumar NYAYADHISH, Nisku (CA); Jason HOLZMUELLER, Lawrence, KS (US)

(21) Appl. No.: 18/693,053

(22) PCT Filed: Oct. 14, 2022
(86) PCT No.: PCT/US2022/046757

§ 371 Date: Mar. 18, 2024

Related U.S. Application Data
(60) Provisional application No. 63/262,578, filed on Oct. 15, 2021.

(51) Int. Cl. H01B 3/42; H01B 1/02; H02K 3/30; H02K 3/44; H02K 5/132

(52) U.S. Cl. CPC H01B 3/427; H01B 1/026; H02K 3/30; H02K 3/44; H02K 5/132

(57) ABSTRACT

A motor lead wire for electric submersible pumps is provided. The lead wire includes solid insulation extruded about a solid copper conductor. The insulation can include a semicrystalline thermoplastic.

### CROSS-REFERENCE TO RELATED APPLICATIONS

The present application claims priority benefit of U.S. Provisional Application No. 63/262,578, filed Oct. 15, 2021, the entirety of which is incorporated by reference herein and should be considered part of this specification.

### BACKGROUND

### Field

The present disclosure generally relates to electric submersible pumps (ESPs), and more particularly to high reliability lead wires for encapsulated ESPs.

### Description of the Related Art

Various types of artificial lift equipment and methods are available, for example, electric submersible pumps (ESPs). An ESP includes multiple centrifugal pump stages mounted in series, each stage including a rotating impeller and a stationary diffuser mounted on a shaft, which is coupled to a motor. In use, the motor rotates the shaft, which in turn rotates the impellers within the diffusers. Well fluid flows into the lowest stage and passes through the first impeller, which centrifuges the fluid radially outward such that the fluid gains energy in the form of velocity. Upon exiting the impeller, the fluid flows into the associated diffuser, where fluid velocity is converted to pressure. As the fluid moves through the pump stages, the fluid incrementally gains pressure until the fluid has sufficient energy to travel to the well surface.

### SUMMARY

In some configurations, a lead wire includes a solid copper conductor; and solid insulation extruded about the conductor.

The insulation can be a semicrystalline thermoplastic. The insulation can be a rigid thermoplastic material. The insulation can be a high modulus and creep resistant thermoplastic material. The insulation can be a composite thermoplastic material having increased thermal conductivity. The insulation can have a thickness in the range of 70-75 mils.

The lead wire can be used in an electric submersible pump motor. For example, the lead wire can be used in an encapsulated stator of an ESP motor. The lead wire can be used in ESPs for geothermal applications.

In some configurations, a method of forming a lead wire for an electric submersible pump includes providing a conductor and extruding solid insulation about the conductor.

The conductor can be a solid copper conductor. The insulation can be a semicrystalline thermoplastic. The insulation can be a rigid thermoplastic material. The insulation can be a high modulus and creep resistant thermoplastic material. The insulation can be a composite thermoplastic material having increased thermal conductivity. The insulation can have a thickness in the range of 70-75 mils.

In some configurations, a stator for an electric submersible pump motor includes a housing; a plurality of laminations forming a lamination stack within the housing; slots extending axially through the lamination stack; windings extending axially through the slots; an end turn area at a top end of the lamination stack in which the windings extend generally circumferentially; encapsulation material surrounding the windings in the end turn area; and a plurality of lead wires coupled to the windings and extending upward from the end turn area. Each of the lead wires includes a solid copper conductor and rigid, high temperature, solid insulation extruded about the conductor.

The insulation can be a semicrystalline thermoplastic. The insulation can be a rigid thermoplastic material. The insulation can be a high modulus and creep resistant thermoplastic material. The insulation can be a composite thermoplastic material having increased thermal conductivity. The insulation can have a thickness in the range of 70-75 mils.

### BRIEF DESCRIPTION OF THE FIGURES

Certain embodiments, features, aspects, and advantages of the disclosure will hereafter be described with reference to the accompanying drawings, wherein like reference numerals denote like elements. It should be understood that the accompanying figures illustrate the various implementations described herein and are not meant to limit the scope of various technologies described herein.

FIG. 1 shows a schematic of an electric submersible pump (ESP) system.

FIG. 2 shows a perspective cut-away view of an example of a motor assembly.

FIG. 3 shows an example electric motor.

FIG. 4 shows a photograph of a portion of an electric motor.

FIG. 5 shows a portion of an electric motor.

FIG. 6 shows an end portion of an encapsulated ESP stator.

FIGS. 7-8 show an end portion of an encapsulated ESP stator including lead wires according to the present disclosure.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements. Commonly, these terms relate to a reference point at the surface from which drilling operations are initiated as being the top point and the total depth being the lowest point, wherein the well (e.g., wellbore, borehole) is vertical, horizontal or slanted relative to the surface.

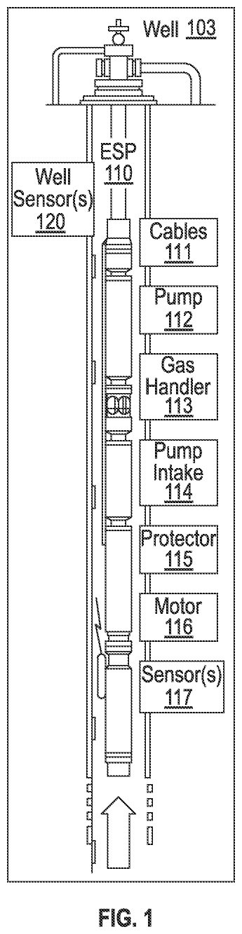

Various types of artificial lift equipment and methods are available, for example, electric submersible pumps (ESP). As shown in the example embodiment of FIG. 1, an ESP 110 typically includes a motor 116, a protector 115, a pump 112, a pump intake 114, and one or more cables 111, which can include an electric power cable. The motor 116 can be powered and controlled by a surface power supply and controller, respectively, via the cables 111. In some configurations, the ESP 110 also includes gas handling features 113 and/or one or more sensors 117 (e.g., for temperature, pressure, current leakage, vibration, etc.). As shown, the well may include one or more well sensors 120.

The pump 112 includes multiple centrifugal pump stages mounted in series within a housing. Each stage includes a rotating impeller and a stationary diffuser. A shaft extends through the pump (e.g., through central hubs or bores or the impellers and diffusers) and is operatively coupled to the motor 116. The shaft can be coupled to the protector 115 (e.g., a shaft of the protector), which in turn can be coupled to the motor 116 (e.g., a shaft of the motor). The impellers are rotationally coupled, e.g., keyed, to the shaft. The diffusers are coupled, e.g., rotationally fixed, to the housing. In use, the motor 116 causes rotation of the shaft (for example, by rotating the protector 115 shaft, which rotates the pump shaft), which in turn rotates the impellers relative to and within the stationary diffusers.

In use, well fluid flows into the first (lowest) stage of the ESP 110 and passes through an impeller, which centrifuges the fluid radially outward such that the fluid gains energy in the form of velocity. Upon exiting the impeller, the fluid makes a sharp turn to enter a diffuser, where the fluid's velocity is converted to pressure. The fluid then enters the next impeller and diffuser stage to repeat the process. As the fluid passes through the pump stages, the fluid incrementally gains pressure until the fluid has sufficient energy to travel to the well surface.

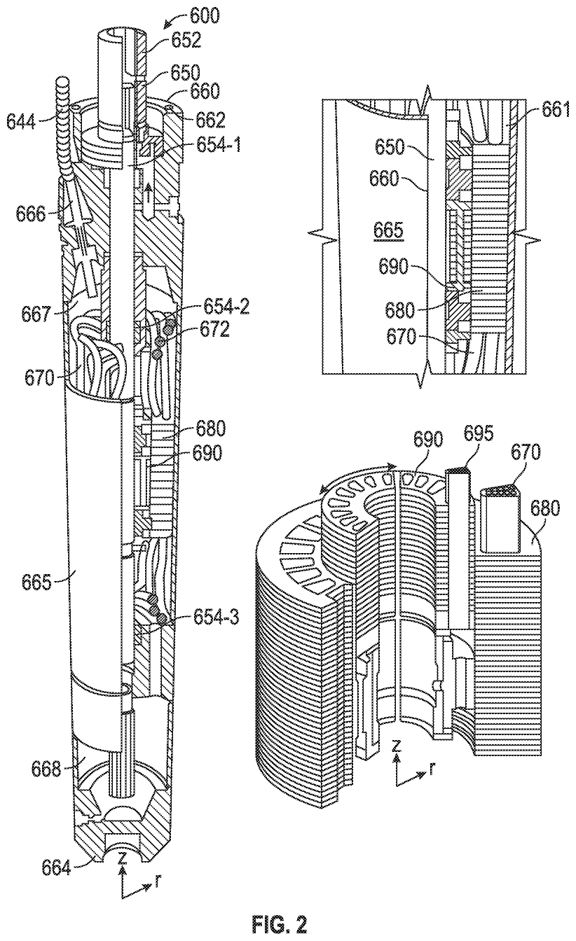

FIG. 2 shows a perspective cut-away view of an example motor assembly 600. As shown, the motor assembly 600 can include a power cable 644 (e.g., MLEs, etc.) to supply energy, a shaft 650, a housing 660 that may be made of multiple components (e.g., multiple units joined to form the housing 660), stacked laminations 680, stator windings 670 of wire (e.g., magnet wire) and rotor laminations 690 and rotor windings 695 coupled to the shaft 650 (e.g., rotatably driven by energizing the stator windings 670).

As shown in FIG. 2, the housing 660 includes an inner surface 661 and an outer surface 665. The housing 660 can define one or more cavities via its inner surface 661. One or more of the cavities may be hermetically sealed. Such a cavity may be filled at least partially with dielectric oil. The dielectric oil may be formulated to have a desired viscosity and/or viscoelastic properties, etc.

As shown, the shaft 650 may be fitted with a coupling 652 to couple the shaft to another shaft. A coupling may include, for example, splines that engage splines of one or more shafts. The shaft 650 may be supported by bearings 654-1, 654-2, 654-3, etc. disposed in the housing 660. A shaft may be reciprocating, for example, where a shaft includes one or more magnets (e.g., permanent magnets) that respond to current that passes through stator windings.

As shown, the housing 660 includes opposing axial ends 662 and 664 with the substantially cylindrical outer surface 665 extending therebetween. The outer surface 665 can include one or more sealable openings for passage of oil (e.g., dielectric oil), for example, to lubricate the bearings and to protect various components of the motor assembly 600. In some configurations, the motor assembly 600 may include one or more sealable cavities. For example, a passage 666 allows for passage of one or more conductors of the cable 644 (e.g., or cables) to a motor cavity 667 of the motor assembly 600 where the motor cavity 667 may be a sealable cavity. As shown, the motor cavity 667 houses the stator windings 670 and the stator laminations 680. In some configurations, an individual winding may include a plurality of conductors (e.g., magnet wires). For example, a cross-section 672 of an individual winding may reveal a plurality of conductors that are disposed in a matrix (e.g., of material or materials) or otherwise bound together (e.g., by a material or materials). In the example of FIG. 2, the motor housing 660 includes an oil reservoir 668, for example, that may include one or more passages (e.g., a sealable external passage and a passage to the motor cavity 667) for passage of oil.

In some configurations, a polymeric matrix may be formed of organic and/or inorganic monomeric and/or polymeric materials. For example, one or more of an epoxy, bismaleimide, polybutadiene, benzoxazine, cyanate ester, silicone, Ring-Opening Metathesis Polymers (ROMP), and preceramic polymers may be utilized. One or more monomers and/or polymers may be amphiphilic, which may facilitate blending in one or more fillers. For example, the functionalized linseed oil marketed as DILULIN™ material (Cargill, Inc., Wayzata, Minnesota) is amphiphilic and can allow for increasing content of one or more inorganic fillers of a composite material. Where DILULIN™ material is mentioned, a functionalized linseed oil other than that marketed as DILULIN™ may optionally be utilized.

In some configurations, a polymeric material can be thermally conductive and electrically insulative and be utilized to encapsulate windings of an electric motor. Such an approach may provide for lower winding temperatures and end coil temperatures through heat dissipation.

An electric motor may include a coil retention system such as, for example, a full winding encapsulation type, a varnished windings type, or an end coil retention type (e.g., one that does not support wires in slots). In some configurations, a glass-fiber tape can be included in a coil retention system where, for example, the glass-fiber tape is wrapped around end turns and where the glass-fiber tape is impregnated with a crosslinking resin.

An encapsulation technique can depend on the type of coil retention system employed. For example, the use of a thermosetting polymer can depend on the type of coil retention system. An encapsulated system can involve use of one or more materials and one or more particular processes. As an example, a varnished windings approach can include use of a solvent-based polybutadiene system, which tends to be more elastomeric than structural. An end coil retention resin can be a silica-filled epoxy, which has suitable structural properties due in part to the fact that the end coil retention provides coil stabilization while holding the end turns and while not supporting wires in the slots.

To maintain mechanical robustness of magnet wire wrapped in a stator of an electric motor, insulated motor windings may use a coil retention system where at least ends of coils are held in place by a structural composite that includes fibrous reinforcement (e.g., one or more of glass, quartz, aramid, etc.) and an organic and/or inorganic polymer matrix.

Dielectric fluids (e.g., motor oils, etc.) can include, for example, one or more of purified mineral oils, polyalphaolefin (PAO) synthetic oils, PFPE (polyperfluoroether), etc. Such dielectric fluids can be relatively resistant to well fluid(s), which can thereby allow an electric motor to function in case of leakage well fluid.

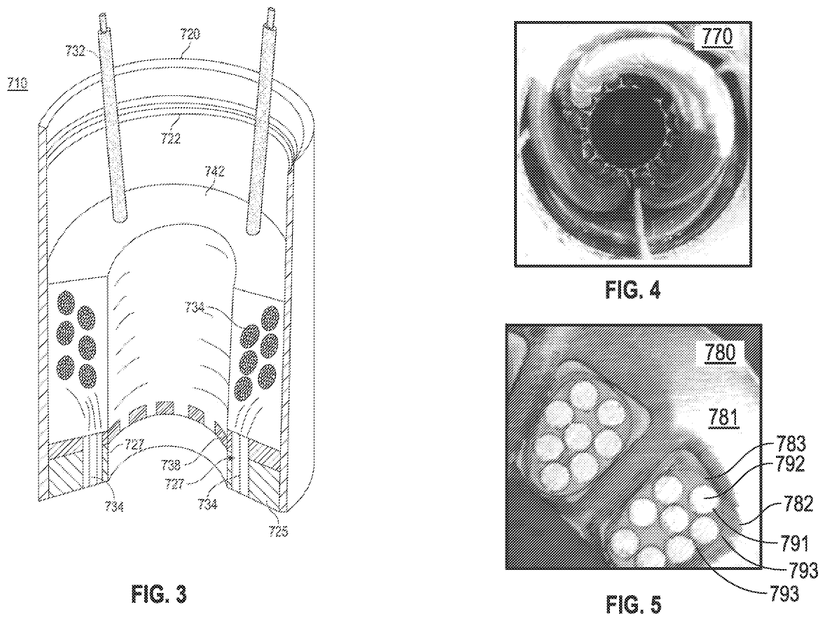

As shown in FIG. 3, an electric motor 710 includes a housing 720 with threads 722. Lead wires (e.g., brush wires) 732 are shown where a number of such wires can correspond to a number of phases. For example, for a three phase electric motor, there can be three lead wires 732 (e.g., two being shown in the cutaway view). The lead wires 732 can be associated with a top or uphole end of an electric motor; whereas, at a bottom or downhole end, a wye point may exist where phases are electrically coupled. As an example, a wye point may be electrically coupled to one or more other components such as, for example, a gauge (e.g., a sensor unit, etc.).

As shown in the example of FIG. 3, the lead wires 732 are electrically coupled to phase windings or phase coils 734 in the end turns area. In the end turns area, the windings or coils 734 can extend or be coiled generally circumferentially. The windings or coils 734 can extend from the end turns axially downward through slots 727 in stator laminations 725. As shown in the example of FIG. 3, a polymeric material 742, which may optionally be a polymeric composite material (e.g., polymeric material that includes one or more fillers), contacts the ends of the windings or coils 734. In other words, the polymeric material 742 can surround or encapsulate the windings or coils 734 in the end turns area. A portion of the polymeric material 742 can extend downwardly through the slots 727 in the laminations 725.

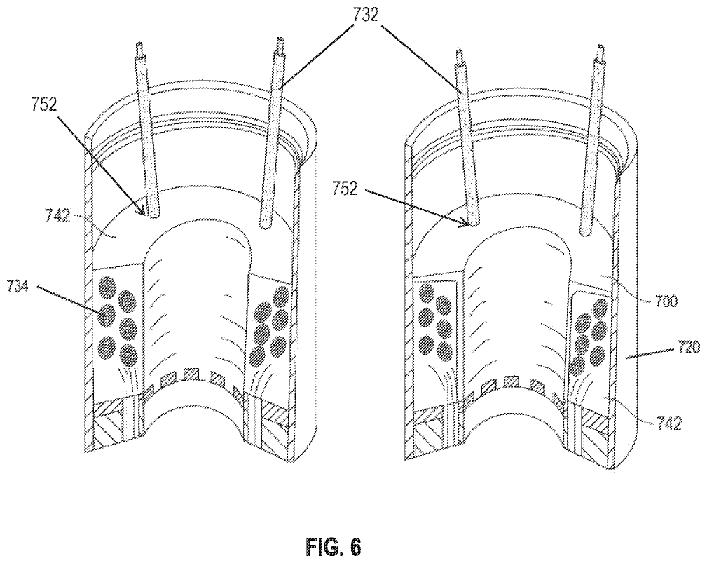

In the example of FIG. 3 and the left side of FIG. 6, a molding insert may be utilized to contain the polymeric material 742 (e.g. encapsulant material) during curing of the polymeric material (e.g., where reactions occur involving at least in part monomers, etc.). In some configurations, an in-situ cover or cap 700, shown on the right side of FIG. 6, acts as in-situ tooling, providing the mold for the encapsulant during curing. However, in this case, the tooling remains in place during use, in the form of the cover or cap 700.

In some configurations, a method can include an injection process for injecting the polymeric material 742 into a cavity of the housing 720 to contact ends of windings or coils 734 (e.g., of magnet wire), a molding process for molding the polymeric material 742 about the ends of the windings or coils in a manner to not interfere with other components of an electric motor (e.g., to create a shaft space and/or rotor space, etc.), an assembly process for assembling an electric motor 710 that includes the stator disposed in the housing 720, an assembly process for assembly of a downhole tool that can utilize the electric motor 710 (e.g., an ESP, etc.), or any one or combination of the aforementioned processes.

FIG. 4 shows a photograph 770 of a portion of an electric motor where resin is applied to glass fabric for the lower portion of the windings shown in the photograph 770 (e.g., upper portion shows the glass fabric without the resin). As an example, windings can be held in place by a polymeric material (e.g., optionally a polymeric composite material) that completely encapsulates end turns and that fills slots. In such an example, air voids may be substantially removed through use of vacuum impregnation and degassing while prepolymer is heated to a low viscosity prior to gelation.

Thermally conductive encapsulants can improve reliability of ESP systems by decreasing motor winding temperatures. Applications can include SAGD, subsea, geothermal, etc. Such materials may be suitable for use in equipment for drilling and measurement operations (e.g., D&M).

FIG. 5 shows a photograph 780 of an example of a portion of a product (e.g., a portion of an example of a stator). In particular, the photograph 780 shows a lamination 781 that includes a slot 782 where slot liner material 783 defines an interior space such that the slot liner material 783 surrounds magnet wire 792 that includes insulation 791. As shown in the photograph 780, polymeric material 793, which may be polymeric composite material, is disposed exteriorly and interiorly with respect to the slot liner material 783. In some configurations, the insulation 791 can be of the order of about 0.1 mm to about 0.3 mm. The slot liner material 783 can be a polymeric film that may be of one or more layers where a layer of the film may be of the order of about 0.1 mm to about 0.3 mm. As shown, the polymeric material 793 can at least partially fill spaces defined by the slot 782 of the lamination 781. In some configurations, an individual plate may be formed of carbon steel with an oxide coating, and a plurality of such plates can be stacked to form the laminations 781.

As an example, heat energy generated during operation of an electric motor that includes the stator of the photograph 780 may be transferred to the polymeric material 793. For example, current in the magnet wire 792 can generate heat due at least in part to resistance of the magnet wire 792. As the polymeric material 793 is in contact with the magnet wire 792 (e.g., via the electrical insulation 791) it can conduct at least a portion of the heat energy away from the magnet wire 792, noting that resistance of the magnet wire 792 may depend on temperature (e.g., consider a wire where resistance increases with temperature or, in other words, where the wire becomes less efficient as temperature increases).

As described herein, stator windings in an ESP motor must be secured mechanically due to their significant weight and axially-biased orientation. Otherwise, the windings can shift vertically during deployment or operation, causing electrical failure. Historically, ESP stator windings have been secured by varnish (coated over all wires and end turns), composite end coil retention systems (covering only the end turns), or fully encapsulated windings. Resin chemistries used for encapsulated windings can advantageously offer low viscosity processing, high glass transition temperatures, excellent electrical, mechanical, and/or thermal properties, and/or hydrolysis resistant chemistries.

Currently, encapsulated ESP stators are used in applications up to 204° C. (400° F.). However, for geothermal ESP applications, the materials must be able to be used at temperatures up to 300° C. (572° F.). Geothermal applications also require high amperage, e.g., 125 Amps and above, and voltages will be closer to operational limits due to the need for high horsepower.

The point or area 752 (shown in FIG. 6) at which the lead wires or magnet wires 732 exit the encapsulated portion of the stator is one of the weakest points of an encapsulated ESP stator. This junction is a natural electrical and mechanical stress concentration point where an electrical fault will most likely occur, and therefore must be protected. The lead wire exit 752 is a particular point of concern in geothermal applications due to the high amperage and voltages used.

Currently available lead wires 732 (sometimes referred to as “brush wires”) are typically either magnet wire (protected by fluoropolymer tubing) or stranded lead wires of a larger gauge with taped or extruded fluoropolymer insulation and tubing. FEP, PFA, and ECA melt below 300° C. PTFE melts in the range of 315° C., but has weak mechanical properties at elevated temperatures. Magnet wire exits by themselves are not capable of carrying the high current required and must be spliced to higher gauge lead wires (e.g., #2 AWG or #1 AWG). Stranded lead wires cause vacuum leaks through the conductor strands during the encapsulation process. Fluoropolymers undergo stress relaxation during attempts to seal on the surface. This compromises the protection of the magnet wire or brush wire and compromises the primary insulation on stranded lead wire.

To address these issues, the present application provides lead wire 732 with a solid conductor and rigid, high-temperature insulation. A lead wire according to the present disclosure can include a solid copper conductor (e.g., coated or bare, #4, #2, or #1 AWG) with a solid extruded insulation. The insulation can be made of or include, a rigid high modulus, creep resistant thermoplastic and/or a composite thermoplastic having increased thermal conductivity. For example, the insulation can be made of or include PEEK, PEK, PEKEKK, PEKEK, PPS (Polyphenyline Sulfide, e.g., Ryton®), and/or another suitable material. Such semicrystalline thermoplastics have excellent sealing properties and melting points above the limits of fluoropolymers. In some configurations, the lead wire includes a solid conductor core, e.g., a solid copper conductor, and insulation made of or including fluoropolymer thermoplastics, such as FEP, PFA, or composite filled versions of fluoropolymer thermoplastics. Insulation of lead wires 732 according to the present disclosure can have a thickness in the range of 70-75 mils.

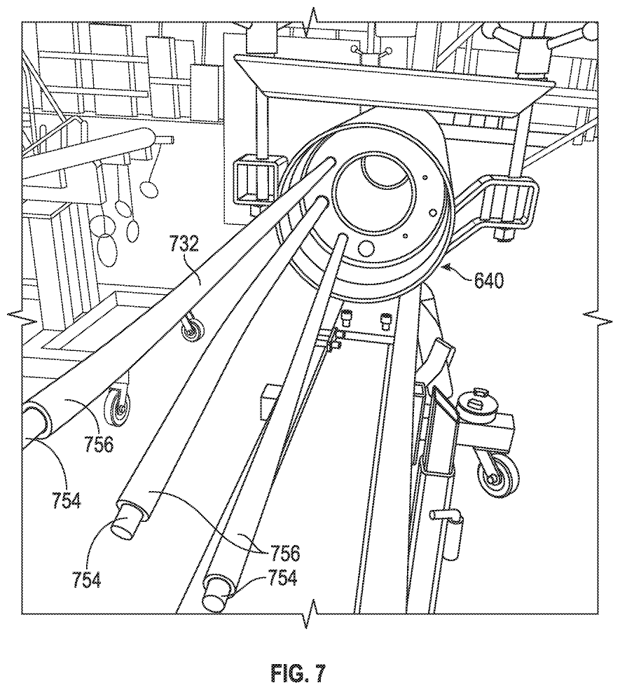

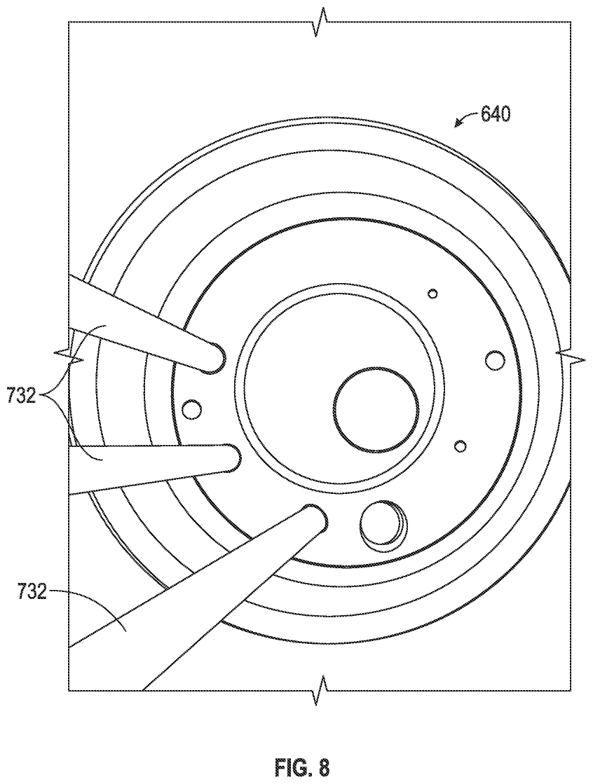

FIGS. 7 and 8 show an encapsulated stator 640 with lead wires 732 according to the present disclosure. As shown, each lead wire 732 includes a solid conductor core 754 surrounded by solid extruded insulation 756. In the illustrated configuration, the lead wire 732 includes #1 AWG high temperature polyaryletherketone insulation. The three leads 732 can be “timed” in specific locations such that the lead wires 732 line up with female terminals for an MLE connection to the motorhead.

In stator configurations including an in-situ cover 700, the lead wire exit 752 can advantageously be sealed, for example, with an elastomer seal. In other words, an interface or area between the cover 700 and the lead wire 732 at or near the lead wire exit 752 can be sealed, for example, with an elastomer seal. Sealing between the cover 700 and lead wire 732 can advantageously facilitate the encapsulation process during manufacturing, as a vacuum is needed to fill with the encapsulation material. Sealing between the cover 700 and lead wire 732 can advantageously provide additional protection for the motor windings downhole. The motor windings can be the weakest part of the motor, due to having the thinnest insulation, closest path to ground, and dielectric material most susceptible to well fluid attack. A seal between the cover 700 and lead wire 732 can help protect the motor windings, for example, from ingress of well fluid, debris, etc. into the motor windings area.

The cover 700 can be made of or include a fiber reinforced epoxy or phenolic. These materials are superior in mechanical properties and thermal conductivity. Furthermore, the polymer matrices can be selected for extreme temperature resistance. Fiber reinforcement can be in the form of glass, quartz, carbon, and/or aramid. Preferably, the fibers are electrically non-conductive (and therefore not carbon fiber). In some configurations, the composite material of the cover 700 is made of sheets of fabric impregnated with resin. The fibers of the fabric can have specific orientations or be random oriented chopped or long fibers. The cover 700 can be manufactured to enhance compatibility with the encapsulation resin, for example via a compatabilizing agent in the phenolic or epoxy compound or a surface treatment. An example of such an agent is epoxidized or phenolic functionalized versions of the encapsulating resin being used. Use of a compatabilizing surface treatment on the cover material can be achieved with chemical etching, plasma treatments, CVD, or application or primers. An example method includes activating the surface of the cover via treatment in a plasma chamber to generate surface hydroxyl groups, following by dipping or brushing with a solvent carried silane material that exhibits good compatibility with the encapsulation resin.

The cover 700 can include a flange portion projecting radially outward from an end of a hollow tube. The flange portion can be positioned on or adjacent the top end or surface of the encapsulant material 742, as shown in FIG. 6. The seal at exit 752 can be between the flange portion of the cover 700 and the lead wire 732. The encapsulant material 742, and encapsulated end coils 734 are positioned radially between the hollow tube of the cap and the housing 720. The cover 700, specifically the hollow tube of the cover 700, can at least partially define a rotor space into which the rotor of the motor is inserted.

While lead wires 732 according to the present disclosure can advantageously be used in ESPs for geothermal applications, they can also be used in various ESP architectures and types. Solid PEEK or similar insulated lead wires 732 could be used in motors of other downhole tools, for example, in completions, well construction, and/or reservoir performance applications.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or 0.1 degree.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. It is also contemplated that various combinations or sub-combinations of the specific features and aspects of the embodiments described may be made and still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above.

What is claimed is:

1. A lead wire comprising:
a solid copper conductor; and
solid insulation extruded about the conductor.

2. The lead wire of claim 1, the insulation comprising a semicrystalline thermoplastic.

3. The lead wire of claim 1, the insulation comprising a rigid thermoplastic material.

4. The lead wire of claim 1, the insulation comprising a high modulus and creep resistant thermoplastic material.

5. The lead wire of claim 1, the insulation comprising a composite thermoplastic material having increased thermal conductivity.

6. The lead wire of claim 1, wherein the insulation has a thickness in the range of 70-75 mils.

7. A method of forming a lead wire for an electric submersible pump, the method comprising:
providing a conductor; and
extruding solid insulation about the conductor.

8. The method of claim 7, wherein the conductor is a solid copper conductor.

9. The method of claim 7, the insulation comprising a semicrystalline thermoplastic.

10. The method of claim 7, the insulation comprising a rigid thermoplastic material.

11. The method of claim 7, the insulation comprising a high modulus and creep resistant thermoplastic material.

12. The method of claim 7, the insulation comprising a composite thermoplastic material having increased thermal conductivity.

13. A stator for an electric submersible pump motor, the stator comprising:
a housing;
a plurality of laminations forming a lamination stack within the housing;
slots extending axially through the lamination stack;
windings extending axially through the slots;
an end turn area at a top end of the lamination stack in which the windings extend generally circumferentially;
encapsulation material surrounding the windings in the end turn area; and
a plurality of lead wires coupled to the windings and extending upward from the end turn area, each lead wire of the plurality of lead wires comprising:
a solid copper conductor; and
rigid, high temperature, solid insulation extruded about the conductor.

14. The stator of claim 13, the insulation comprising a thermoplastic material.

15. The stator of claim 13, the insulation comprising a semicrystalline thermoplastic material.
